(19) United States
(12) Patent Application Publication
(10) Pub. No.: US 2013/0236688 A1
(43) Pub. Date: Sep. 12, 2013

(54) SANDWICH COMPONENT AND METHOD FOR PRODUCING SAME

(71) Applicants: Benno Stamp, Stuttgart (DE); Tobias Blumenstock, Stuttgart (DE); Ralph Greiner, Leonberg (DE); Hubert Bieder, Denkendorf (DE)

(72) Inventors: Benno Stamp, Stuttgart (DE); Tobias Blumenstock, Stuttgart (DE); Ralph Greiner, Leonberg (DE); Hubert Bieder, Denkendorf (DE)

(73) Assignee: Daimler AG, Stuttgart (DE)

(21) Appl. No.: 13/883,815

(22) PCT Filed: Sep. 24, 2011
(86) PCT No.: PCT/EP2011/004794

§ 371 Date: May 14, 2013

(30) Foreign Application Priority Data
Nov. 9, 2010 (DE) 10 2010 050 872.1

(51) Int. Cl. B32B 3/12; B32B 37/24

(52) U.S. Cl. CPC B32B 3/12; B32B 37/24
USPC 428/116; 156/62.2

(57) ABSTRACT

A sandwich component with a moisture barrier and a method for the production thereof. The sandwich component has at least one top layer (2) and one honeycomb core. The top layer (2) has a cover layer (2a) made from reinforcing fibres with a thermoplastic matrix, and the honeycomb has a cellulose-based material and has a plurality of webs (1). The top layer (2) has a barrier layer (2c) made from a thermoplastic material, the melting properties corresponding to the melting properties of the cover layer. An intermediate layer (2b) between the cover layer (2a) and the barrier layer (2c) has reinforcing fibres made from the cover layer (2a) and thermoplastic material of the barrier layer (2c). The reinforcing fibres are permeated by one proportion of the thermoplastic matrix material of the cover layer (2a) and by one proportion of the thermoplastic material of the barrier layer (2c).

The invention relates to a sandwich component, which comprises a cellulose-based honeycomb core and at least one cover layer, and a production method for the same.

In the course of the lightweight construction strategy in the construction of motor vehicles to reduce both the fuel consumption and thus the costs, as well as carbon dioxide emissions, components with a sandwich structure are increasingly being used, which, due to the low density of the material forming the core, can provide a clearly reduced weight compared to conventional components and sufficient mechanical strength properties from a suitable selection of top layer material. Further advantages of such sandwich structures are present in their thermal and acoustic properties.

A multilayer moulded part and a method for the production thereof are known from DE 10 2004 015 472 B4, wherein the materials for this moulded part are to be very light, cheap and able to be recycled without any problems, as well as not being susceptible to air humidity in individual cases. The top layers of the moulded part, which are arranged on the open sides of the honeycomb chambers of a honeycomb layer, before the thermoplastic connection with the honeycomb chambers, consist of a non-woven material with needles only on one side, in the manner of a random web containing the thermoplastic polymer fibres, wherein the other, cotton-like side of the non-woven material penetrates the honeycomb chambers after the hot deformation and solidification.

In order to be able to use the lightweight construction potential of such a sandwich structure in further components, a reduction in the surface-related mass of the cover layers without losing the mechanical strength properties would be desirable. To date, cover layers with a reduced surface-related mass disadvantageously no longer represent sufficient moisture barriers. The object thus arises from the above prior art to create a sandwich structure with cover layers, which are to have a reduced surface-related mass without compromising mechanical strength and are to be impermeable to moisture to protect the honeycomb core.

This object is solved by the sandwich component having the features of claim 1.

A further object exists in the creation of a simple and cost-effective production method for such a sandwich component.

This object is solved by the method having the features of claim 6.

Developments of the component and the method thereof are embodied in the respective sub-claims.

A sandwich component embodied according to the invention consists of at least one top layer and one honeycomb core. The top layer is formed by a cover layer made from reinforcing fibres with a thermoplastic matrix, while the honeycomb core consists of a cellulose-based material and a plurality of webs, the end edges of which fix a plane against which the top layer is brought.

In a first exemplary embodiment of the sandwich component according to the invention, the top layer comprises a barrier layer made from a thermoplastic material between the cover layer and the webs of the honeycomb core. The melting properties of the thermoplastic material of the barrier layer here correspond to the melting properties of the thermoplastic matrix material of the cover layer, so that an intermediate layer between the cover layer and the barrier layer can be formed, which has reinforcing fibres made from the cover layer and thermoplastic material of the barrier layer. Corresponding melting properties in particular mean melting points, glass transition temperatures and melt viscosities that essentially do not diverge from one another. The matrix of the intermediate layer is thus formed by a polymer mixture or even by a polymer blend, which comprises the thermoplastic of the barrier layer and the thermoplastic of the cover layer. Disregarding traces, the barrier layer contains no reinforcing fibres. Traces of reinforcing fibres are fibres that extend from the intermediate layer into the barrier layer.

The reinforcing fibres of the intermediate layer are here permeated by one proportion of the thermoplastic material of the cover layer and by one proportion of the thermoplastic material of the barrier layer. The thermoplastic barrier layer, by means of which the intermediate layer is connected by a bonded connection to the cover layer, on the one hand prevents the reinforcing fibres from the cover layer from penetrating the inner spaces of the honeycomb between the webs, thereby reducing the fibre proportion in the cover layer that forms mechanical strength, and on the other hand forms an integrated moisture barrier that protects the cellulose-based honeycomb core from being penetrated by moisture. The inner spaces of the honey comb are thus virtually free from reinforcing fibres that are separate or not bonded by thermoplastic. The honeycomb interior is thus free from reinforcing fibres, disregarding traces. Traces of reinforcing fibres are individual fibres that extend from the intermediate layer into the barrier layer and extend through them.

Due to the barrier layer, the cover layer can be reduced with respect to its surface weight, since all available reinforcing fibres can be used without losses occurring as a result of fibres in the hollow spaces of the honeycomb in the cover layer. The intermediate layer that has been strongly consolidated with the increased thermoplastic proportion additionally contributes to the mechanical strength of the top layer.

In a particularly advantageous embodiment, the thermoplastic material of the barrier layer can be the same thermoplastic material as the thermoplastic matrix material of the cover layer. For this, thermoplastics such as a polyamide, an acrylonitrile butadiene styrene, a polyproplyene and/or another polyolefin are considered.

The cover layer of the sandwich component according to the invention can have a thickness in a range from 0.4 to 0.8 mm, preferably approximately 0.6 mm, while the sum of the thicknesses of the barrier layer and the intermediate layer is in a range from 0.2 to 0.4 mm and in particular approximately 0.3 mm. The sum of the layer thicknesses of the barrier layer and the intermediate layer here corresponds to somewhat more than the strength of a film that is used to form these layers. It is preferred to use thermoplastic films with a thickness of 0.1 to 0.4 mm to produce the barrier layer.

It is of particular significance that the web end edges are received into the thermoplastic barrier layer of the top layer. The end edges of the webs are thus completely enclosed by the thermoplastic of the barrier layer. The webs are supported laterally by the barrier layer or by the thermoplastic of the barrier layer in the connection zone to the cover layer. It is hereby achieved on the one hand that the top layers are connected relatively tightly to the webs of the honeycomb core and, on the other hand, a strong sealing of the honeycomb core from the outside is achieved. The web is sealed to the edge virtually by the thermoplastic. It is only by encircling or flowing around, according to the invention, the web edges that a strong sealing can take place. Since the thermoplastic of the barrier layer is not fibre-reinforced, a highly dense and zero-defect border is achieved. The web material and the honeycomb inner spaces are hereby protected effectively from moisture entering. The sealing is then particularly advantageous if the honeycomb core consists of paper or cardboard, since these are porous materials wherein moisture can be received directly via unprotected edges.

Here, the depth of the bordering of the end edges by the thermoplastic of the barrier layer does not play an inconsiderable role. The depth of the border is particularly dependent on the relationship between the width of the web (web width) and the thickness of the barrier layer. Thus, the thickness of the barrier layer is deemed to be in the region between the honeycomb webs, since the barrier layer thickness in the region of the border naturally turns out to be lower. It is particularly preferred for the thickness of the barrier layer to be above 30% and below 150% of the web width, in particularly from 30 to 50%. A thickness of the barrier layer that is far greater than the web width typically does not entail any further advantages.

The width of the webs preferably lies in the range of 200 to 600 μm. It is particularly preferred for honeycomb cores made from paper to be used, wherein the web width lies in the range of between 200 and 400 μm.

It is preferable for the depth of the border, or the length with which the end edge of the web of the honeycomb core penetrates the barrier layer, to be at least 80% of the web width. 100 to 200% of the web width is preferred. The depth of the border to both sides of the web or above the lateral extent of the web can thus vary. A depth of the border that is greater than twice the web width typically does not entail any further advantages.

Due to the lateral bordering of the web end edges or the comparably deep penetration of the webs into the top layer, a particularly fixed connection is ensured, since shearing forces can also be well absorbed.

The reinforcing fibres with a thermoplastic matrix used to form the cover layer can be formed by a fibre mat, a non-woven fibre, for example, or a hybrid web, a hybrid mesh or knit etc.

The thermoplastic matrix of the cover layer can also be inserted in the form of non-consolidated thermoplastic fibres. These are present in the web, etc., as well as the reinforcing fibres. The fibres, both thermoplastic and reinforcing, can also be present in bundled form as rovings. A variant, in which reinforcing fibres are enclosed by a thermoplastic matrix layer individually or in bundles, is also conceivable. As an alternative to such hybrid structures, the reinforcing fibres with the thermoplastic matrix can also be provided by a pre-consolidated thermoplastic plate with an embedded reinforcing fibre web. During the processing procedure, the thermoplastic fibres fuse and form the thermoplastic matrix accordingly.

The reinforcing fibres can be natural fibres, glass fibres, carbon fibres, polymer fibres, in particular aramid fibres or a combination thereof.

A method for the production of such a sandwich component generally comprises the formation of the top layer of the sandwich component, which is arranged at least on one side of the honeycomb core—the underside or top side, such that the top layer comes into contact with the honeycomb core. To form a top layer, first a thermoplastic polymer film on the cellulose-based honeycomb core is filed down to a plane that is fixed by the web edges of the honeycomb core. Applying adhesives is not necessary. A semi-finished product is arranged above this, which consists of reinforcing fibres and a thermoplastic polymer matrix.

This arrangement from honeycomb core, polymer film and semi-finished product is heated and compressed in a pressing tool, such that the thermoplastic polymer matrix and the polymer film consisting of thermoplastic materials that have melting properties corresponding to one another at least partially fuse. Due to the fused material of the thermoplastic polymer film, the formation of the barrier layer takes place directly conterminous to the honeycomb core, while, by consolidating the reinforcing fibres with the thermoplastic polymer matrix in a polymer film or barrier layer, the cover layer is formed in a completed position of the top layer. Between the cover layer and the barrier layer, the intermediate layer is formed by consolidating the reinforcing fibres of the cover layer in a position near to a polymer film or barrier layer with one proportion of the thermoplastic matrix material of the cover layer and one proportion of the thermoplastic material of the barrier layer. In this way, a heavily consolidated material consisting of reinforcing fibres and an increased thermoplastic proportion arises in the intermediate layer, which is made up of the matrix material and the polymer film material.

Furthermore, due to the at least partial fusing of the thermoplastic polymer matrix and the polymer film, a strong bond between the honeycomb core and the top layer is achieved, wherein the web end edges are received at least into the thermoplastic barrier layer of the top layer. During the partial fusing of the polymer film, the web end edges are flowed around by this, such that a bordering of the end edges by thermoplastic occurs. It is thus particularly important that the barrier layer not be fibre-reinforced. The thermoplastic can hereby flow unhindered and form a well-sealed and zero-defect border. The end edges are hereby closed off completely at the sides and on top by the sealed thermoplastic. Due to the lateral bordering of the web end edges or the comparably deep penetration of the webs into the top layer, shearing forces can also be absorbed well.

The depth of the bordering of the web end edges or the sinking of the honeycomb core into the thermoplastic film can, for the given thermoplastic, be controlled by the pressure of the pressing tool, for example.

The heating in the pressing tool is here carried out by temperature loading in the region of the melting temperature of the thermoplastic material. It is preferable for the temperature of the polymer matrix and polymer film to be in the range from the glass transition temperature to the melting temperature of the corresponding polymer. The heating temperature of the pressing tool is thus at least equal to the melting temperature.

To obtain a moulded sandwich component, the honeycomb core can be moulded before the top layer is formed, while it is first moistened with water by spraying or vaporisation. The moistened honeycomb core can then be arranged in a pressing tool with a stamp and a die, which show a predetermined shape of the sandwich component, and then the reshaping of the moistened honeycomb core takes place therebetween at a temperature in a range of 40° C. to 200° C. under subjection of pressure.

The arrangement of the polymer film according to the invention and the semi-finished product follows this, the simultaneous fusing and surface-fusing of which takes place by compression in a correspondingly moulded pressing tool.

According to the invention, a sandwich component is thus created wherein penetration of fibres into the honeycomb chamber is prevented by the barrier layer, where they no longer have a reinforcing effect, but rather it is achieved advantageously that all the reinforcing fibres present in the top layer contribute to the reinforcement. Thus, the thickness of the cover layer can be reduced, wherein the barrier layer that prevents penetration into the honeycomb interior simultaneously serves as a moist barrier and protects the cellulose-based honeycomb core from being penetrated by moisture.

These and other advantages are demonstrated by the description below with reference to the accompanying figures. The reference to the figures in the description serves to support the description and to facilitate understanding of the subject matter. The figures are only a schematic depiction of an embodiment of the invention.

The following can be seen in the figures:

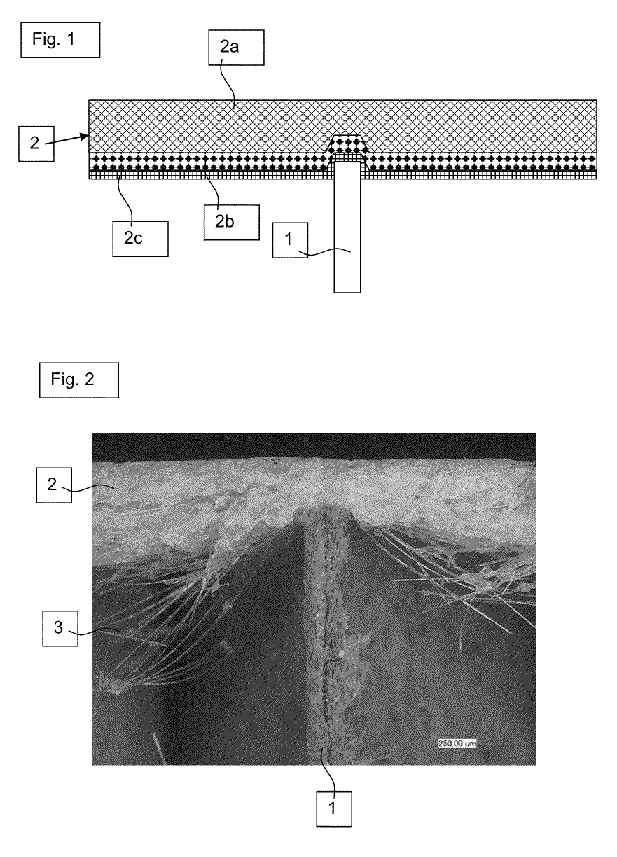

FIG. 1 a schematic side sectional view of a connection region of a honeycomb web on the top layer,

FIG. 2 a microscopic comparative illustration of a connection region without a barrier layer,

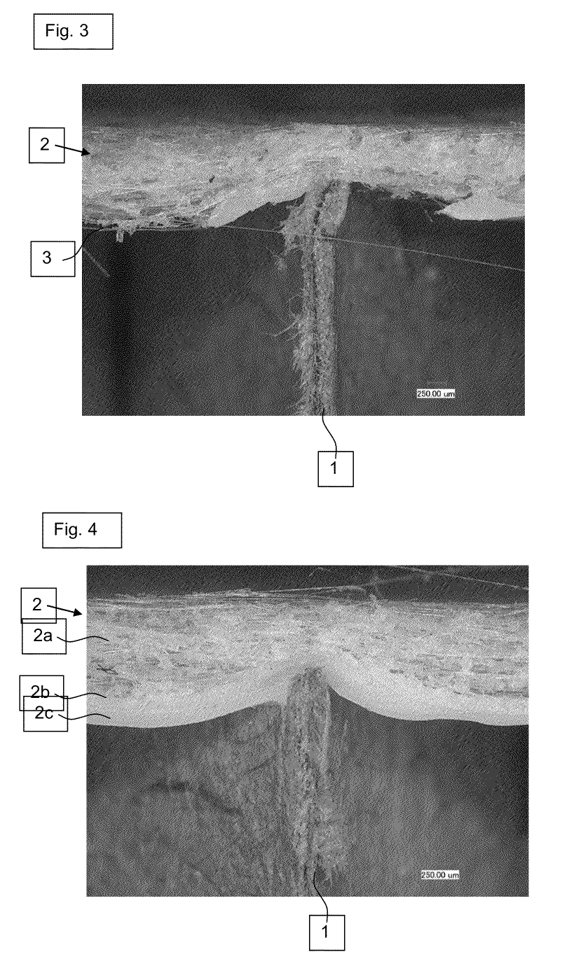

FIG. 3 a microscopic comparative illustration of a connection region, wherein a 0.08 mm-thick film was used, which forms no barrier layer,

FIG. 4 a microscopic illustration of a connection region of a sandwich component embodied according to the invention, wherein a 0.3 mm-thick film was used to form the barrier layer.

The sandwich component according to the invention, which enables a reduction in the surface-related mass or the surface weight of the top layers in order to be able to yield the lightweight construction potential of the sandwich structures in various constructions, has a top layer 2, as is schematically illustrated in FIG. 1.

The top layer 2, which is brought against the end edges of the webs 1 of a honeycomb core, has, as a top layer, i.e. the layer that is as far from the web 1 as possible, the cover layer 2a made from reinforcing fibres with a thermoplastic matrix.

The term “honeycomb” does not serve to denote the structure of the honeycomb core in a limited fashion, but rather means a structure formed from webs with low density and high rigidity. Suitable honeycomb structures comprise the typical hexagonal “honeycomb structure”, just like wave-like, circular, rhombical or rectangular fold structures, as well as irregularly designed “organic”, fabric-like structures.

Among other things, paper and card are considered as the cellulose-based material for the honeycomb core.

The reinforcing fibres for the formation of the cover layer can be present in the form of non-woven material, a random web or fibre mats with fibres, webs, meshes and cores, aligned both in one direction and in many. The use of a hybrid thread is also hereby conceivable, such that a fibrous semi-finished product containing thermoplastic fibres that form the matrix is used, as well as reinforcing fibres. Here, the reinforcing fibres are natural fibres, glass fibres, carbon fibres, polymer fibres, in particular aramid fibres—however, combinations of different fibres can also be used.

The top layer 2 has, according to the invention, a barrier layer 2c between the cover layer 2a and the webs 1, said barrier layer consisting of a thermoplastic material that here is similar to the thermoplastic matrix material. However, according to the invention, at least the melting properties of the thermoplastic materials of the cover layer and barrier layer must correspond to each other. It is preferable for the thermoplastic matrix material and the thermoplastic material of the barrier layer to be the same thermoplastic material, which can be, for example, a polyamide, an acrylonitrile butadiene styrene, a polyproplyene or another polyolefin.

The barrier layer 2c on the one hand prevents reinforcing fibres on the cover layer 2a from penetrating the honeycomb interior, which is bordered by the webs 1, such that all reinforcing fibres remain within the top layer 2 and contribute to the reinforcing effect. Since there are no longer any “losses” of reinforcing fibres, the surface weight of the top layer 2 can be reduced. Additionally, as a purely thermoplastic layer, the barrier layer 2c offers the advantage of operating as a moisture barrier and thus providing sufficient protection from moisture for the paper honeycomb core, even when the surface weight is reduced. Here, an intermediate layer 2b is designed between the barrier layer 2c and the cover layer 2a, which is consolidated into a fibre-matrix composite material by a heavily consolidated material made from reinforcing fibres from the cover layer 2a, both with the matrix material from the cover layer 2a and with thermoplastic material from the barrier layer 2c, said composite material being characterized by an increased thermoplastic material proportion.

This three-layer construction of the top layer 2 can be produced in a simple manner by means of the method according to the invention, wherein a thermoplastic polymer film is arranged on the honeycomb core and on the polymer film of a fibre semi-finished product with the thermoplastic polymer matrix, which are heated and compressed together in a pressing tool, whereby the reinforcing fibres are consolidated in the matrix melt. In order to obtain a simultaneous fusing and surface-fusing of the thermoplastic polymer film with the thermoplastic polymer matrix of the semi-finished product, similar thermoplastics are used, preferably the same thermoplastic material. The film used for the formation of the barrier layer 2c must hereby be relatively thick in order to establish counter-pressure for the reinforcing fibres on the cover layer 2a. During the pressing, the film establishes counter-pressure onto the non-woven material and thus effects a consolidation and adhesion of the non-woven material.

In this way, FIG. 3 shows a top layer 2 on a web 1, wherein only a 0.08 mm-thick film was arranged here between the honeycomb core and the cover layer. The thickness of this film was not sufficient to consolidate the reinforcing fibres from the cover layer; it does not form any barrier layer, such that reinforcing fibres 3 can still penetrate the spaces in the honeycomb. The honeycomb web is partially bordered by the top layer. Here, the border is partially formed from fibrous and porous material and partially by the thermoplastic of the film. The thickness of the film is here insufficient to guarantee a sealed border of the edge of the web.

This is also very clear from FIG. 2, in which, for comparative purposes, the connection region of a sandwich component without a barrier layer is depicted, wherein no film was used. Reinforcing fibres 3 penetrating the honeycomb interior are to be seen clearly here, which thus no longer contribute to the reinforcing effect of the top layer 2. The web is virtually not received into the top layer, or there is virtually no border to the web. There is no sealed closing above, as well as at the sides of the web edge. In fact, the web edge rests against porous material that is interfused with fibres.

As can be seen in FIG. 4, there is also a different sandwich component according to the invention: here, no reinforcing fibres penetrate the honeycomb interior, but rather all reinforcing fibres present in the top layer 2 contribute to the reinforcing effect. Here, the cover layer 2a has an approximate thickness of 0.6 mm, while both layers—the intermediate layer 2b and the barrier layer 2c—amount to approximately 0.3 mm, as can be achieved by a 0.3 mm-thick film. In this way, the surface weight of the top layers 2 can be reduced without any loss of reinforcing properties, while the barrier layer 2c simultaneously represents an effective moisture barrier. As a material of the honeycomb core, paper with a web width of approximately 300 μm was used. The width of 650 μm depicted in the microscopic illustration arises from the fact that the web was cut at an angle during the preparation. The depth of the border with thermoplastic is approximately 450 μm on the left-hand side and approximately 300 μm on the right-hand side. The web edge is thus completely bordered by the thermoplastic on the top and at the sides. The thermoplastic thus leads to the edges being sealed from moisture and to the edges being supported laterally in the connecting zone.

1. A sandwich component, comprising
at least one top layer (2), which comprises a cover layer (2a) made from reinforcing fibres with a thermoplastic matrix, and
a honeycomb core consisting of a cellulose-based material in the form of a plurality of webs (1) having web end edges,
wherein the web end edges fix a plane against which the top layer (2) is brought,
wherein the top layer (2) between the cover layer (2a) and the webs (1) of the honeycomb core comprises a barrier layer (2c), which is obtained from a thermoplastic material without reinforcing fibres, the melting properties of which correspond to the melting properties that the thermoplastic matrix material of the cover layer has (2a), and
wherein an intermediate layer (2b) is provided between the cover layer (2a) and the barrier layer (2c), which has reinforcing fibres made from the cover layer (2a) and thermoplastic material of the barrier layer (2c),
wherein the reinforcing fibres of the intermediate layer (2b) are permeated by a proportion of the thermoplastic matrix material of the cover layer (2a) and by a proportion of the thermoplastic material of the barrier layer (2c), and
wherein the end edges of the webs (1) of the honeycomb core are bordered by the thermoplastic barrier layer (2c) and are hereby connected to the top layer (2).

2. The sandwich component according to claim 1, wherein the length with which the end edges of the web of the honeycomb core penetrates the barrier layer, or the depth of the border, is over 80% of the web width.

3. The sandwich component according to claim 1, wherein the thermoplastic material of the barrier layer (2c) and the thermoplastic matrix material of the cover layer (2a) are the same thermoplastic material.

4. The sandwich component according to claim 1, wherein the cover layer (2a) has a thickness in a range of 0.4 to 0.8 mm, and a sum of the thicknesses of the barrier layer (2c) and the intermediate layer (2b) is in a range from 0.2 to 0.4 mm.

5. The sandwich component according to claim 1, wherein the thickness of the barrier layer is greater than 30% and less than 150% of the web width.

6. The sandwich component according to claim 1, wherein the reinforcing fibres are natural fibres, glass fibres, carbon fibres, polymer fibres or a combination thereof.

7. A method for the production of a sandwich component according to claim 1, wherein the top layer (2) is formed on at least one of the sides—the underside of the honeycomb core or the top side of the honeycomb core, and wherein the web end edges of the honeycomb core fix a plane against which the top layer (2) is brought,
comprising the following steps:
arranging a thermoplastic polymer film on the honeycomb core,
arranging a semi-finished product on the polymer film, wherein the semi-finished product consists of reinforcing fibres with a thermoplastic polymer matrix,
heating and compressing the arrangement consisting of honeycomb core, polymer film and semi-finished product in a pressing tool, while at the same time at least partially fusing the thermoplastic polymer matrix and the polymer film made from thermoplastic material, which have melting properties that correspond to each other,
forming the barrier layer (2c) from the material of the thermoplastic polymer film,
forming the cover layer (2a) by consolidating the reinforcing fibres with the thermoplastic polymer matrix in a position of the top layer (2) that is far removed from the polymer film, and
forming the intermediate layer (2b) by consolidating the reinforcing fibres of the cover layer (2a) in a position that is close to the polymer film, with one proportion of the thermoplastic matrix material of the cover layer (2a) and with one proportion of the thermoplastic material of the barrier layer (2c).

8. The method according to claim 7, comprising providing for the cover layer
a non-woven fibre, a hybrid web, a fibre mesh or fibre knit made from reinforcing fibres and non-consolidated thermoplastic fibres, or
a pre-consolidated thermoplastic plate with embedded reinforcing fibres.

9. The method according to claim 7, comprising the following steps:
fusing the thermoplastic polymer matrix and the polymer film under heated conditions by loading with a temperature in the region of the melting temperature of the thermoplastic polymer, in particular to a temperature region that extends from one glass transition temperature to the melting temperature, and thereupon
flowing around web end edges by the thermoplastic polymer of the polymer film by forming a border of the web end edges
cooling the polymers by forming a fixed connection between the top layer (2) and the webs (1) of the honeycomb core and sealing the web end edges with the thermoplastic polymer.

10. The method according to claim 7, comprising the following steps:
shaping the honeycomb core before the arrangement of the polymer film on the same, by moistening the honeycomb core with water by spraying or vaporising, arranging the moistened honeycomb core in a pressing tool with a stamp and a die, which provide a predetermined shape of the sandwich component, and reshaping the moistened honeycomb core in the pressing tool by subjecting pressure and at a temperature in a range of 40° C. to 200° C.

11. The sandwich component according to claim 2, wherein the length with which the end edges of the web of the honeycomb core penetrates the barrier layer, or the depth of the border, is from 100 to 200% of the web width.

12. The sandwich component according to claim 3, wherein the thermoplastic material is a polyamide, an acrylonitrile butadiene styrene, a polyproplyene and/or another polyolefin.

13. The sandwich component according to claim 4, wherein the cover layer (2a) has a thickness of 0.6 mm, and a sum of the thicknesses of the barrier layer (2c) and the intermediate layer (2b) equal to 0.3 mm.

14. The sandwich component according to claim 5, wherein the thickness of the barrier layer is from 30 to 50% of the web width.

15. The sandwich component according to claim 1, wherein the reinforcing fibres include aramid fibres.
